(19) United States
(12) Patent Application Publication
(10) Pub. No.: US 2005/0135733 A1
(43) Pub. Date: Jun. 23, 2005

(54) Integrated optical loop mirror

(76) Inventors: Benoit Reid, Orleans (CA); Kelvin Prosyk, Ottawa (CA)

Correspondence Address: STIKEMAN ELLIOTT, 1600-50 O'CONNOR STREET, OTTAWA, ON, KIP LS2, CA

(21) Appl. No.: 11/013,335

(22) Filed: Dec. 17, 2004

Related U.S. Application Data
(60) Provisional application No. 60/530,658, filed on Dec. 19, 2003.

(51) Int. Cl. G02B 6/26

(52) U.S. Cl. 385/15; 385/39

(57) ABSTRACT

An integrated optical loop mirror has an optical coupler and an optical waveguide loop formed on a semiconductor substrate such that the waveguide connects two output ports of the coupler. Optical signals entering the input port of the coupler are directed around the waveguide loop and back to the input port, the device thereby provides an optical reflection or mirror function on a substrate. The integrated optical loop mirror is easily manufactured to provide accurate control of phase and magnitude of reflections and can be configured to provide wavelength dependent or independent reflections. It allows for placement flexibility, unlike cleaved facets which are restricted to chip edges. Other suitable substrates include glass and lithium niobate (LiNbO3). It can be constructed using various types of couplers and waveguides including photonic crystals. It is well suited to monolithic integrated optical designs incorporating lasers, such as distributed feedback (DFB) lasers, semiconductor optical amplifiers (SOA), integrated optical taps and Mach-Zehnder interferometers.

### CROSS-REFERENCE TO RELATED APPLICATIONS

This application claims priority from U.S. Provisional Patent application Ser. No. 60/530,658 filed Dec. 19, 2003.

### MICROFICHE APPENDIX

Not Applicable.

### TECHNICAL FIELD

The present invention relates to optical communications systems and particularly to integrated optical loop mirrors.

### BACKGROUND OF THE INVENTION

Semiconductor lasers typically use reflectors or mirrors to define a lasing region where photons can be reflected back and forth so that they can readily stimulate emissions from the gain medium. Various reflection techniques are known in the prior art such as cleaved facets, grating reflectors and etched facets.

Cleaved facets are typically formed by scribing lines or nicks in the semiconductor wafer to generate fracture locations. Mechanical force is then applied to fracture the wafer along the scribe lines. This is typically a labour intensive manual process performed by a skilled operator. Placement accuracy is limited to about ±10 μm, which is problematic for phase sensitive applications.

Coatings can be added to the cleaved facet to control reflections. In order to control reflections at multiple wavelengths, multiple coatings are required which can be both expensive and impractical. An important disadvantage of this technique is that these cleaved facets must be located at the edges of the resulting semiconductor chip, which restricts the possibility of integrating devices having such cleaved facets on the same substrate as other opto-electronic devices.

Gratings in waveguides such as, for example Bragg gratings, can be used for reflecting optical signals and are well known in the art. The reflection characteristics of gratings are inherently wavelength dependent and meticulous design and calibration are required to enable a wide tuning range which can increase costs. An extra growth step is typically required to produce the gratings on the waveguides and therefore adds to manufacturing costs. Optical gratings, especially those designed to provide a wide tuning range are bulky and when implemented on a semiconductor substrate, use up valuable chip real estate.

Another technique for producing optical reflections is by etched mirrors. The fabrication is relatively straight forward but etched mirrors are quite lossy due to the rough edges of the etched surface. Etched mirrors have poor reflection control and a low reflectance at perpendicular incidence. Applying coatings to the etched mirrors in order to control reflections is also difficult. Etched mirrors have wavelength independent reflection characteristics which is very difficult to overcome when wavelength dependent characteristics are desired.

Non-linear optical fiber loop mirrors are known in the art. A non-linear optical fiber loop mirror 100 is illustrated in FIG. 1 and consists of a directional optical coupler 102 having a first input port 104 and a second input port 106 and two output ports 108, 110 and a fiber loop 112 connecting both output ports 108, 110 of the coupler 102 and a non-linear element 114 located asymmetrically in the fiber loop 112. An optical signal 116 entering the optical coupler 102 at input port 104 is split in two and each half 118, 120 travels around the loop 112 in opposite directions. The non-linear element 114 introduces a phase shift in each of the counter-rotating optical signals at different times due to its asymmetrical location in the fiber loop 112. The result is that the counter-rotating signals reach the coupler 102 with different phase shifts and their interaction can cause a portion of the signals to be directed to the second input port 106. Such optical loop mirrors rely on characteristics of non-linear elements in the fiber loop 112 to affect the interaction of the counter-rotating signals. Some embodiments use especially long fiber loops in order to obtain the desired results. Optical fiber loop mirrors are not well suited for reflection purposes as a mirror as part of an active region of a laser for example because of the bulk of the optical fiber and the cost of interfacing the optical fiber to the laser.

Optical waveguide ring resonators are also known in the art. An optical waveguide ring resonator 200 is illustrated in FIG. 2 and consists of a directional optical coupler 202 having a first input port 204 and a second input port 206 and two output ports 208, 210 and an optical waveguide loop 212 connecting output port 210 of the coupler 202 back to input port 206 to create an optical ring in which an optical signal can pass repeatedly until wavelength dependent characteristics induce resonance. No reflection function is exploited in such a configuration.

Accordingly, a method and system for providing a cost effective and compact optical reflection function, which lends itself to integration with other optical elements on a substrate, remains highly desirable.

### SUMMARY OF THE INVENTION

It is therefore an object of the present invention to provide an integrated optical loop mirror which can be constructed on a substrate.

Accordingly, an aspect of the present invention provides an optical loop mirror comprising an optical coupler and an optical waveguide formed on a substrate. The optical coupler has at least one nominal input port and at least a first nominal output port and a second nominal output port. The optical waveguide has a first end and a second end, wherein the first end is optically coupled to the first nominal output port and the second end is optically coupled to the second nominal output port.

In some embodiments, the substrate is a semiconductor substrate.

In some embodiments, the substrate is comprised of glass.

In some embodiments, the substrate is comprised of lithium niobate.

In some embodiments, the optical coupler is a multimode interference (MMI) coupler.

In some embodiments, the optical coupler has only the one nominal input port and the first and second nominal output ports.

In some embodiments, the optical coupler has a second nominal input port.

In some embodiments, the optical coupler and said optical waveguide are monolithically formed on the semiconductor substrate.

In some embodiments, the optical coupler and said optical waveguide are formed of photonic crystals.

In some embodiments, the optical loop mirror comprises a whispering gallery type waveguide.

In some embodiments, the optical waveguide is coupled to said optical coupler such that light energy can flow through said waveguide in only one pass in each direction.

In some embodiments, the optical loop mirror is integrated on said semiconductor substrate with other optoelectronic devices.

In some embodiments, the optical loop mirror is incorporated in a distributed feedback (DFB) laser.

In some embodiments, the optical loop mirror is incorporated in a semiconductor optical amplifier (SOA).

In some embodiments, the optical loop mirror is incorporated in a Mach-Zehnder interferometer.

In some embodiments, the optical loop mirror is incorporated in a dual-pass semiconductor optical amplifier (SOA), wherein a first SOA is connected to a first nominal input port of the optical loop mirror and a second SOA is connected to a second nominal input port of the optical loop mirror.

In some embodiments, the waveguide has a wavelength filter between the first end and second end.

In some embodiments, the wavelength filter has a coupled ring resonator.

In other embodiments, the waveguide has a transmission tap between the first end and second end.

A further aspect of the present invention provides an optical loop mirror for reflecting an optical signal. The optical loop mirror has an optical coupler and an optical waveguide formed on a substrate. The optical coupler has at least one nominal input and at least a first nominal output and a second nominal output. The optical waveguide has a first end and a second end, wherein the first end and the second end are connected to the optical coupler such that the optical signal can flow through the waveguide in only one pass in each direction.

Yet another aspect of the present invention provides a method for manufacturing an optical loop mirror. The method has steps of forming an optical coupler on a semiconductor substrate and forming an optical waveguide on the semiconductor substrate. The optical coupler has at least one nominal input port and at least a first nominal output port and a second nominal output port. The optical waveguide has a first end and a second end, wherein the first end is optically coupled to the first nominal output port and the second end is optically coupled to the second nominal output port.

### BRIEF DESCRIPTION OF THE DRAWINGS

Further features and advantages of the present invention will become apparent from the following detailed description, taken in combination with the appended drawings, in which:

FIG. 1 is a schematic illustration of a nonlinear optical fiber loop mirror of the prior art;

FIG. 2 is a schematic illustration of an optical waveguide ring resonator of the prior art;

FIG. 3 is a schematic illustration of a 1×2 optical loop mirror according to an embodiment of the present invention;

FIG. 4 is a schematic illustration of a 2×2 optical loop mirror according to an embodiment of the present invention;

FIG. 5 is a schematic illustration of a 2×3 optical loop mirror according to an embodiment of the present invention;

FIG. 6 is a schematic illustration of a 1×2 optical loop mirror with a filtered loopback according to an embodiment of the present invention;

FIG. 7 is a schematic illustration of a 1×2 optical loop mirror with a transmission tap according to an embodiment of the present invention;

FIG. 8 is a schematic illustration of a 2×2 optical loop mirror with a transmission tap according to an embodiment of the present invention;

FIG. 9 is a schematic illustration of a pseudo two-port circulator using a 2×2 optical loop mirror according to an embodiment of the present invention;

FIG. 10 is a schematic illustration of a distributed feedback laser with controlled facet phase according to an embodiment of the present invention;

FIG. 11 is a schematic illustration of a dual-pass semiconductor optical amplifier according to an embodiment of the present invention;

FIG. 12 is a schematic illustration of multi-parallel semiconductor optical amplifier (SOA) according to an embodiment of the present invention;

FIG. 13 illustrates a physical representation of the 1×2 optical loop mirror of FIG. 3; and

FIG. 14 illustrates a physical representation of the 1×2 optical loop mirror of FIG. 3, implemented using a whispering gallery type waveguide loop.

It will be noted that, throughout the appended drawings, like features are identified by like reference numerals.

### DETAILED DESCRIPTION OF THE PREFERRED EMBODIMENT

The present invention provides an integrated optical loop mirror which can be constructed on a semiconductor, glass or lithium niobate (LiNbO₃) substrate. It provides great improvement over prior art integrated mirror solutions such as cleaved facets, Bragg gratings, etched mirrors and Mach-Zehnder interferometers. Optical loop mirrors can be placed on a wafer to within photo-lithographic accuracy (currently, about 0.1 microns). This is particularly advantageous for the terminating facet phase of a distributed feedback (DFB) laser, for example. The optical loop mirror also offers better performance than current etched mirrors.

The placement of an optical loop mirror on a semiconductor wafer is not restricted to the edge of the wafer as is the case with cleaved facet mirrors. This allows for much higher integration of optoelectronic elements or optical systems on a single wafer. The magnitude and phase of the reflection can be accurately controlled over wavelength (including making it wavelength independent), either by design or dynamically, which offers more flexibility than a Bragg reflector.

The present invention is thus well suited as a building block for constructing highly integrated optical circuits and especially monolithical photonic integrated circuits.

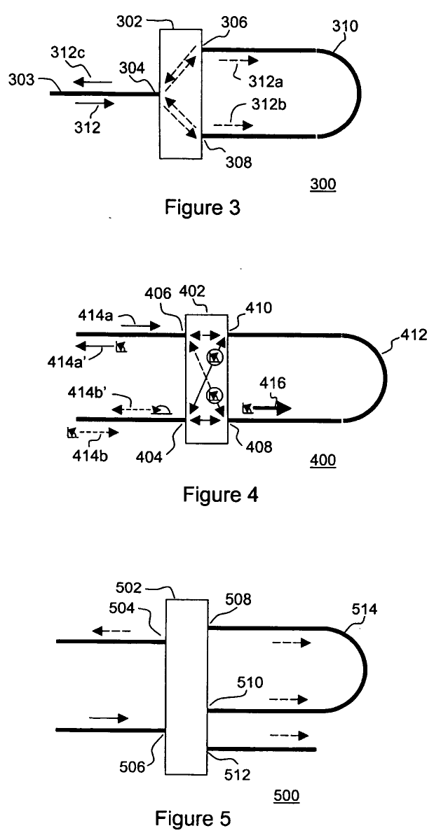

FIG. 3 illustrates a first embodiment 300 of the optical loop mirror of the present invention. The optical loop mirror is monolithically formed on a semiconductor substrate. An input signal waveguide 303 connects to a 1×2 optical coupler 302, formed on a semiconductor substrate, via a nominal input port 304 and two nominal output ports 306, 308. An optical waveguide 310, formed on the same substrate, is connected to the optical coupler 302 such that a first end of the optical waveguide 310 is connected to output port 306 and a second end of the optical waveguide 310 is connected to output port 308, such that optical signals exiting output port 306 are looped back into output 308.

In use, an optical signal 312 enters input port 304, is split by the optical coupler 302 and half the signal 312a exits port 306 and the other half of the signal 312b exits port 308. Each half signal, 312a, 312b loop back into the other output port 308 and 306 respectively. The optical coupler 302 recombines the signals into signal 312c which exits the optical coupler 302 by nominal input port 304.

For all practical purposes, optical waveguide 310 has wavelength independent transmission characteristics and since the split optical signals symmetrically counter-propagate in the waveguide loop, the optical loop mirror 300 behaves as an optical mirror, reflecting the signal 312 back from port 304. Thus an integrated high performance mirror can be provided which is easy to manufacture using current technologies and can be located anywhere on a semiconductor wafer.

In a preferred embodiment, the optical coupler 302 is a 3-dB multimode interference (MMI) coupler. Other split ratios and other types of couplers such as directional couplers or Y-junctions, can be used as well.

A recent technique for waveguiding, reported extensively in the technical literature, uses materials having photonic band gaps, otherwise known as photonic crystals. Photonic crystals are well suited for constructing optical loop mirrors of the present invention, and can yield especially compact implementations. There is also a renewed interest in Y-junction type couplers when constructed using photonic crystals.

FIG. 4 illustrates a 2×2 optical loop mirror embodiment 400 of the present invention. In this variation, coupler 402 is a 2×2 multimode interference (MMI) optical coupler having a first nominal input 404 and a second nominal input port 406 and nominal output ports 408, 410. The MMI coupler introduces a differential phase shift between the output ports 408, 410 such that optical signals passing from port 404 to port 410, and signals passing from port 406 to 408, encounter a 90° phase delay. Optical signals passing from port 404 to port 408, and signals passing from port 406 to 410, encounter no phase delay. In a useful situation, optical signal 414a enters port 406, and optical signal 414b which is identical to optical signal 414a but with a 90° phase delay, enters input port 404. In this situation, due to the phase interactions in the coupler 402, optical signals 414a and 414b arrive at port 410, 180° out of phase and effectively cancel each other out. Optical signals 414a and 414b are combined at port 408 and since signal 414a encounters 90° phase delay and optical signal 414b already has a 90° phase delay, the two signals combine to form optical signal 414 which propagates through waveguide 412 in a counter-clockwise direction only, from port 408 to port 410. The optical coupler 402 splits signal 416 and part of the signal exits port 406 with no additional phase delay as signal 414a′ and the other part of the signal exits port 404 as signal 414b′ with an additional phase delay of 90°. Thus signal 414a is effectively reflected back from port 406 with a 90° phase shift and signal 414b is effectively reflected back from port 404 with a 90° phase shift. The unique ability of this embodiment to direct optical signals in one direction around the mirror loop can have many useful applications, especially where it is desired to perform specific processing of the optical signal before being “reflected” back. It would be impractical to design such a device using optical fiber because it is very difficult to define phase using optical fiber. By contrast, because the present invention can be manufactured a chip using photolithography, it is easy to achieve the manufacturing tolerances required to control phase easily.

FIG. 5 illustrates a third embodiment 500 of the optical loop mirror of the present invention. In this embodiment, a 2×3 optical coupler 502 has two nominal input ports 504, 506 and three nominal output ports 508, 510, 512. Two of the output ports 508, 510 are connected by waveguide loop 514. Its operation is similar to that of the previous embodiments with the added feature of having one output port 512, free for transmission. Thus, a portion of the input signals can be reflected back to the input ports by the waveguide 514 and a portion can be transmitted out of output port 512.

As can be seen from the embodiments described above, many variations of the basic loop mirror are possible. To generalize the above examples, the basic optical loop mirror of the present invention is a semiconductor substrate having formed on it, an M×N-port optical coupler having M input ports and N output points, wherein at least two of the output ports are looped back to each other via an optical waveguide loop, also formed on the same substrate, in order to provide a reflection function. Many variations of the design are possible, including multiple waveguide loops, waveguide loops with different lengths to generate reflections with different delays, using various types of couplers or couplers with different splitting ratios.

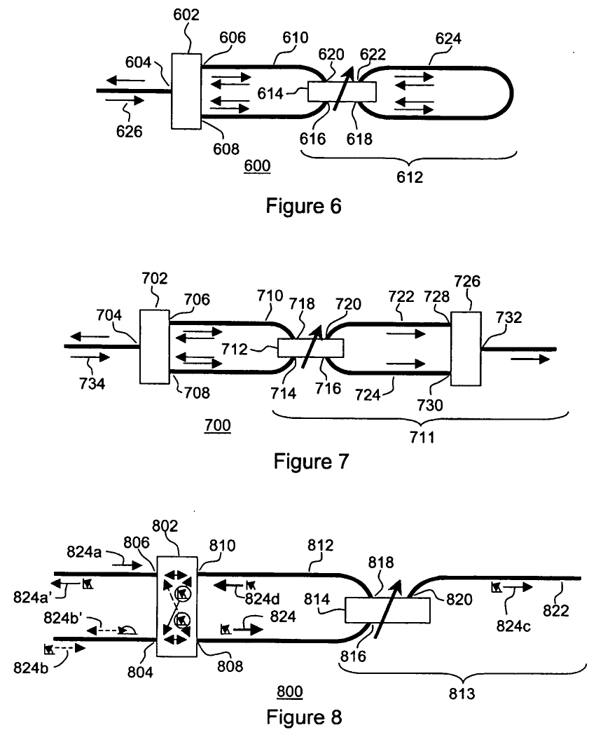

In other embodiments of the present invention, the waveguide loops can be interrupted by a number of different devices. FIG. 6 illustrates a fourth embodiment 600 of the optical loop mirror of the present invention. In this embodiment, a first optical coupler 602 has one nominal input port 604 to accept optical signal 626 and two nominal output ports 606, 608 which are looped back to each other by waveguide loop 610. Waveguide 610 contains a coupled ring resonator 612 which acts as a wavelength filter. Coupled ring resonator 612 is composed of a second optical coupler 614 and an optical waveguide loop 624. The arrow through the symbol for optical coupler 614 in FIG. 6, denotes that the optical coupler 614 can be controlled either by design or dynamically in order to affect coupling to the resonator ring 624. Optical coupler 614 has input/output ports 616, 618, 620 and 622. Port 622 is looped back to port 618 by optical waveguide loop 624 to provide the resonance ring. Other types of filters can also be used in this configuration. A filter network could be used in place of coupled ring resonator 612. Such a filter network could include auto-regressive elements, moving average elements as well as active elements to dynamically control the wavelength and Q of the filter.

FIG. 7 illustrates a fifth embodiment 700 of the optical loop mirror of the present invention. In this embodiment, the optical loop mirror 700 has a transmission tap in the loop. This not only allows partial transmission through the optical loop mirror but can also be used to control the effective reflectance of the optical loop mirror by allowing precise control over the percentage of light reflected back to the input. In this embodiment, a 1×2 optical coupler 702 has a nominal input port 704 to accept optical signal 734 and two nominal output ports 706, 708 which are looped back to each other by waveguide loop 710. The waveguide loop 710 has a transmission tap 711 to tap off a portion of the optical signal flowing through waveguide 710. Transmission tap 711 consists of a 2×2 controllable optical coupler 712 having input/output ports 714, 716, 718 and 720; waveguides 722, 724; and a 1×2 optical coupler 726 acting as a signal combiner. In operation, a portion of the optical signal entering port 718 continues through to port 714 and a portion is diverted to port 716. The coupling ratio can be controlled by controllable coupler 712. Likewise, a portion of the optical signal entering port 714 continues through to port 718 and a portion is diverted to port 720. The diverted signal exiting port 716 flows through waveguide 724 to port 730 of coupler 726 where it combines with the diverted signal exiting port 720 and flowing through waveguide 722 to port 728. The combined diverted signals then exit port 732. Thus the signals diverted by controllable coupler are tapped off and made available at port 732; and the signals not diverted are reflected back out of input port 704.

FIG. 8 illustrates a variation of the two input optical loop mirror of FIG. 4 having a transmission tap 813 in the mirror loop 812. The concept of tapping the optical signal is similar to that of the embodiment of FIG. 7 in that a controllable optical coupler 814 is used divert a portion of the optical signal flowing through the mirror loop but since the optical signal only flows in one direction, only a 2×1 controllable optical coupler 814 is needed and only one waveguide 822 is needed to transport the diverted the signal 824c and a combiner is not required.

Thus in operation, in a useful situation, optical signal 824a enters port 806, and optical signal 824b which is identical to optical signal 824a but with a 90° phase delay, enters input port 804. In this situation, due to the phase interactions in the coupler 802, optical signals 824a and 824b arrive at port 810, 180° out of phase and effectively cancel each other out. Optical signals 824a and 824b are combined at port 808 and since signal 824a encounters 90° phase delay and optical signal 824b already has a 90° phase delay, the two signals combine to form optical signal 824 which propagates through waveguide 812 in a counter-clockwise direction only, from port 808, through controllable coupler 814 to port 810. A portion of the optical signal 824 entering port 816 of controllable coupler 814, continues through port 818 to port 810 as signal 824d and a portion is diverted through port 820 to waveguide 822 as signal 824c. The optical coupler 802 splits the returning signal 824d and part of the signal 824 exits port 806 with no additional phase delay as signal 824a′ and the other part of the signal exits port 804 as signal 824b′ with an additional phase delay of 90°. Thus signal 824a is effectively reflected back from port 806 with a 90° phase shift and signal 824b is effectively reflected back from port 804 with a 90° phase shift. Thus, the effective reflectance of the optical loop mirror 800 can be controlled by controlling the coupling ratio of controllable coupler 814. Equivalently, the tapped optical power, which is the portion of the optical signal which is not reflected, can be controlled.

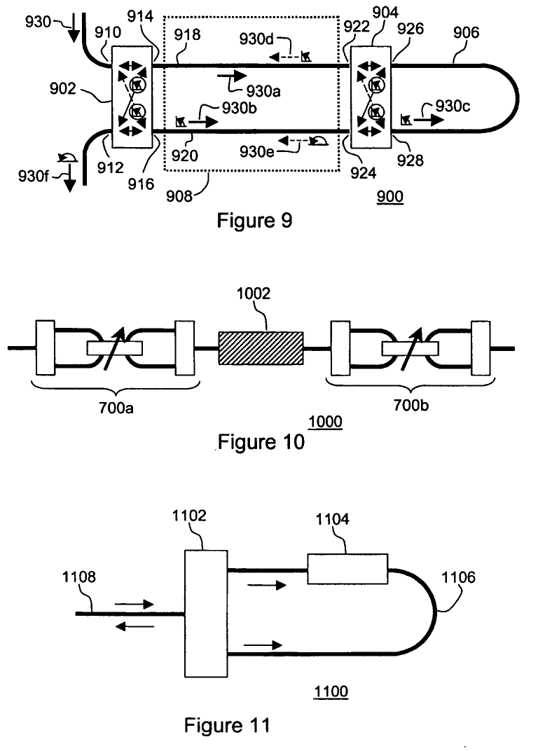

In many applications it is desirable to have an optical signal reflected back along the input path, as illustrated in the preceding embodiments. In some applications however, it is desirable to have an optical signal reflected back along a portion of the input path but then exit via a different path in the manner of an optical circulator. FIG. 9 illustrates an integrated pseudo two-port optical circulator embodiment 900 of the present invention. This embodiment is based on the 2×2 optical loop mirror of FIG. 4, integrated with a second 2×2 multimode interference (MMI) optical coupler 902 and optical device 908 which performs identical operations to the phase and magnitude of the optical signals flowing through the two parallel waveguides 918, 920. Thus, in operation, optical signal 930 enters MMI coupler 902 via port 910. Optical coupler 902 splits the signal 930 into signals 930a and 930b, signal 930b undergoing a 90° phase delay. Signal 930a exits port 914 and flows through waveguide 918 of device 908 and enters port 922 of MMI optical coupler 904. Signal 930b exits port 916 and flows through waveguide 920 of device 908 and enters port 924 of MMI optical coupler 904. (This embodiment illustrates one method of generating two signals having a 90° phase difference as used in the embodiment of FIG. 4.) Coupler 904 causes signals 930a and 930b to combine into signal 930c having a 90° phase delay by virtue of the phase interactions as described with reference to FIG. 4. Signal 930c flows in a counter-clockwise direction around waveguide 906 and back into port 926 where it is split into signal 930d having a 90° phase shift and signal 930e having a 180° phase shift. Signal 930d flows through waveguide 918 into port 914 of coupler 902 and signal 930e flows through waveguide 920 into port 916 of coupler 902. Phase interactions within coupler 902 cancel the combined signals directed to port 910 and direct the combined signals out of port 912 as signal 930f having a phase delay of 180°. As long as device 908 performs identical operations to optical signals flowing through waveguides 918, 920, the signal 930 will be reflected out of port 912. This embodiment is well suited to implementing a dual-pass Mach-Zehnder interferometer.

Mach-Zehnder interferometers (MZI) are commonly fabricated using lithium niobate (LiNbO3) and this material is well suited for implementing MzIs according to the present invention. Lithium niobate provides good optical coupling to optical fiber and it can be easily patterned photo-lithographically. Lithium niobate also exhibits strong linear electro-optical effects which can be used to change the index of refraction dynamically and thus is well suited for building fast efficient modulators.

FIG. 10 illustrates a distributed feedback (DFB) laser with controlled facet phase in an embodiment of the present invention. The DFB laser 1000 has an active region 1002 bounded by optical loop mirrors 700a, 700b with transmission taps to provide controlled reflections for the active region. This design permits photo-lithographically terminated gratings, easy integration with a wavelength locker and/or a back facet monitor. This embodiment also permits the design of dynamically controllable front and back facet reflectivity by using optical couplers with controllable coupling ratios. The operation of the optical loop mirror with transmission tap is described with reference to FIG. 7.

With reference to FIG. 11, a dual-pass semiconductor optical amplifier 1100, is illustrated. It is based on the configuration of the embodiment of FIG. 4, but with a section of active gain material 1104 in the optical waveguide loop 1106.

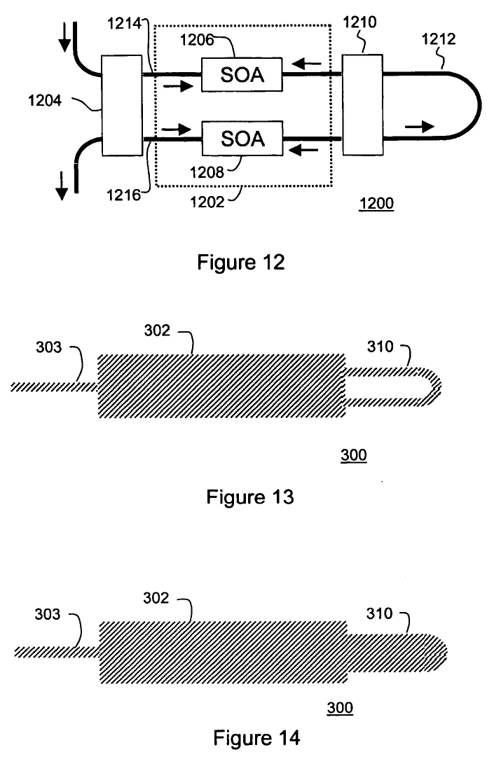

With reference to FIG. 12, a multi-parallel semiconductor optical amplifier (SOA) 1200 is illustrated. It is based on the configuration of the integrated pseudo two-port optical circulator of FIG. 9, the operation of which has been previously described. Optical device 1202 comprises two semiconductor optical amplifiers (SOA) 1206 and 1208, spanning waveguides 1214 and 1216 respectively, optical signals in the waveguides 1214, 1216 receive light amplification in both directions through SOAs 1206, 1208, all the while, keeping the output signal separated from the input signal thereby obviating the need for an external circulator.

A conventional SOA has a carrier density profile which is symmetric about the center and slightly non-uniform along the length. The degree of non-uniformity is a result of forward and backward propagating amplified-spontaneous emission (ASE), and increases with applied current which generates this emission. When a signal is then coupled into the SOA, the non-uniformity increases, and shifts toward the output facet where the power is the strongest, and the depletion of carrier-density-dependent gain is the largest. By contrast, with the optical loop mirror multi-parallel SOA embodiment of the present invention, the signal is coupled into both facets simultaneously, thus maintaining the symmetry and reducing the degree of non-uniformity. Advantages of the optical loop mirror implementation of include, higher gain due to a more efficient use of carriers and a reduction in noise figure due to a more uniform carrier distribution. For an input power large enough to saturate the gain, the higher efficiency is a result of undepleted gain available to the signal at both facets. At the same time, the uniformity of the depletion is improved, as the split signals are both equally affected by the forward- and backward-propagating ASE. As the noise figure degrades with higher depletion, this may result in a lower noise figure.

In some respects, the optical loop mirror SOA principle is similar to the use of counter-propagating pumps in the design of erbium-doped fiber amplifiers (EDFAs) and has similar advantages of gain and noise figures over conventional optical amplifiers. The optical loop mirror SOA, however uses counter-propagating signals instead of counter-propagating pumps.

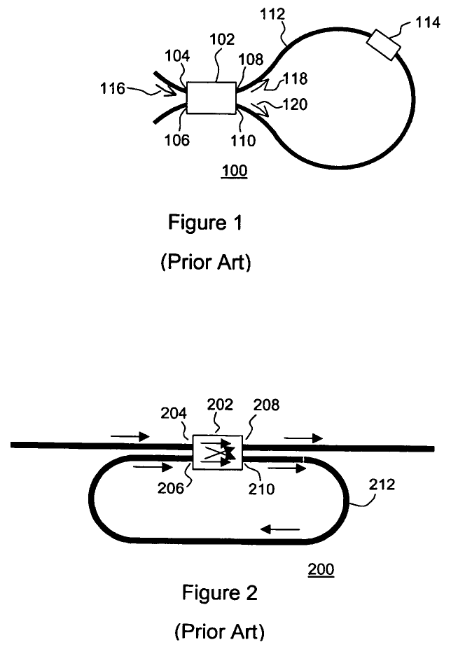

FIG. 13 illustrates a physical representation of the basic optical loop mirror of FIG. 1. An input signal waveguide 303 connects to a 1×2 optical coupler 302, formed on a semiconductor substrate, which connects to optical waveguide 310.

FIG. 14 illustrates a physical representation of the basic optical loop mirror of FIG. 1, implemented using a whispering gallery type looped waveguide 310. An input signal waveguide 303 connects to a 1×2 optical coupler 302, formed on a semiconductor substrate, which connects to whispering gallery optical waveguide 310. The whispering gallery waveguide reflects the optical signal off of the outer curved surface to direct the signal.

The embodiment(s) of the invention described above is(are) intended to be exemplary only. The scope of the invention is therefore intended to be limited solely by the scope of the appended claims.

1. An optical loop mirror comprising:
an optical coupler formed on a substrate, the optical coupler having at least one nominal input port and at least a first nominal output port and a second nominal output port;
an optical waveguide formed on said substrate, the optical waveguide having a first end and a second end,
wherein the first end is optically coupled to the first nominal output port and the second end is optically coupled to the second nominal output port.

2. An optical loop mirror as claimed in claim 1, wherein said substrate is selected from the group comprising a semiconductor substrate, glass and lithium niobate.

3. An optical loop mirror as claimed in claim 1, wherein said optical coupler is a multimode interference (MMI) coupler.

4. An optical loop mirror as claimed in claim 1, wherein said optical coupler further comprises a second nominal input port.

5. An optical loop mirror as claimed in claim 1, wherein said optical coupler and said optical waveguide are monolithically formed on said semiconductor substrate.

6. An optical loop mirror as claimed in claim 1, wherein said optical coupler and said optical waveguide are formed of photonic crystals.

7. An optical loop mirror as claimed in claim 1, wherein said optical waveguide comprises a whispering gallery type waveguide.

8. An optical loop mirror as claimed in claim 1, wherein said optical waveguide is coupled to the optical coupler such that light energy can flow through the waveguide in only one pass in each direction.

9. An optical loop mirror as claimed in claim 2, wherein said waveguide further comprises a wavelength filter between the first end and second end.

10. An optical loop mirror as claimed in claim 12, wherein said wavelength filter comprises a coupled ring resonator.

11. An optical loop mirror as claimed in claim 2, wherein said waveguide further comprises a transmission tap between the first end and second end.

12. An optical loop mirror as claimed in claim 2, wherein said optical loop mirror is integrated on said semiconductor substrate with other opto-electronic devices.

13. A distributed feedback (DFB) laser comprising an optical loop mirror as claimed in claim 12.

14. A semiconductor optical amplifier (SOA) comprising an optical loop mirror as claimed in claim 12.

15. A dual-pass semiconductor optical amplifier (SOA) arrangement comprising:
an optical loop mirror as claimed in claim 4;
a first SOA formed on said semiconductor substrate;
a second SOA formed on said semiconductor substrate;
wherein said first SOA is connected to said first nominal input port and said second SOA is connected to said second nominal input port.

16. An optical loop mirror adapted for reflecting an optical signal, the optical loop mirror comprising:
an optical coupler formed on a substrate, said optical coupler having at least one nominal input and at least a first nominal output and a second nominal output;
an optical waveguide formed on said substrate, said optical waveguide having a first end and a second end,
wherein the first end and the second end are connected to said coupler such that the optical signal can flow through said waveguide in only one pass in each direction.

17. An optical loop mirror as claimed in claim 16, wherein said substrate is selected from the group comprising a semiconductor substrate, glass and lithium niobate.

18. An optical loop mirror as claimed in claim 16, wherein said optical coupler is a multimode interference (MMI) coupler.

19. An optical loop mirror as claimed in claim 16, wherein said optical coupler further comprises a second nominal input port.

20. An optical loop mirror as claimed in claim 16, wherein said optical coupler and said optical waveguide are monolithically formed on said semiconductor substrate.

21. An optical loop mirror as claimed in claim 16, wherein said optical waveguide comprises a whispering gallery type waveguide.

22. An optical loop mirror as claimed in claim 16, wherein said optical waveguide is coupled to the optical coupler such that light energy can flow through the waveguide in only one pass in each direction.

23. An optical loop mirror as claimed in claim 16, wherein said waveguide further comprises a wavelength filter between the first end and second end.

24. An optical loop mirror as claimed in claim 23, wherein said wavelength filter comprises a coupled ring resonator.

25. An optical loop mirror as claimed in claim 17, wherein said waveguide further comprises a transmission tap between the first end and second end.

26. An optical loop mirror as claimed in claim 17, wherein said optical loop mirror is integrated on said semiconductor substrate with other opto-electronic devices.

27. A Mach-Zehnder interferometer comprising an optical loop mirror as claimed in claim 16.
